(19) United States
(12) Patent Application Publication
(10) Pub. No.: US 2013/0094797 A1
(43) Pub. Date: Apr. 18, 2013

(54) Optical Transmitter With Tunable Chirp

(71) Applicants: Xueyan Zheng, Andover, MA (US); Kevin McCallion, Winchester, MA (US); Michael Deutsch, Derry, NH (US)

(72) Inventors: Xueyan Zheng, Andover, MA (US); Kevin McCallion, Winchester, MA (US); Michael Deutsch, Derry, NH (US)

(73) Assignee: FINISAR CORPORATION, Horsham, PA (US)

(21) Appl. No.: 13/272,261

(22) Filed: Oct. 13, 2011

(51) Int. Cl. G02F 1/035

(52) U.S. Cl. 385/3

(57) ABSTRACT

An optical transmitter with chirp control includes an input polarizer having an input that receives an optical signal. The input polarizer polarizes the optical signal along an input polarization axis. A Mach-Zehnder modulator includes an optical input that is coupled to an output of the input polarizer and an electrical input that receives a modulation signal. The Mach-Zehnder modulator modulates the optical signal with the modulation signal. The input polarization axis of the input polarizer is chosen to achieve a desired chirp of the modulated optical signal. An output polarizer is coupled to the output of the Mach-Zehnder modulator. The output polarizer polarizes the modulated optical signal along a desired output polarization axis that combines TE and TM mode polarizations.

The section headings used herein are for organizational purposes only and should not to be construed as limiting the subject matter described in the present application in any way.

### INTRODUCTION

Mach-Zehnder external electro-optic modulators are widely used in optical communications transmitters because they have many desirable characteristics. One desirable characteristic of Mach-Zehnder modulators is that they can be configured to provide a widely adjustable chirp parameter αₘ. The chirp parameter αₘ can be expressed as the ratio of the sum of the phase change in each arm of the Mach-Zehnder interferometer (Δφ₁+Δφ₂) to the difference in the phase change in each arm of the Mach-Zehnder interferometer (Δφ₁−Δφ₂) as follows:

αₘ=(Δφ₁+Δφ₂)/(Δφ₁−Δφ₂).

Many known Mach-Zehnder modulators are operated in a push-pull configuration where both arms of the Mach-Zehnder interferometer are biased around a common value and each arm is driven to provide a phase change with signs opposing each other. In this configuration, Δφ₁=−Δφ₂, which results in chirp-free modulation (αₘ=0). In recent years, it has been determined that optical transmission performance with optical signals having transmission wavelengths in the non-zero fiber dispersion wavelength range of 1.55 microns can be improved by modulating signals with a small negative chirp parameter. Optical transmission performance is improved because modulation with a small negative chirp parameter provides a slight pulse compression. See, for example, A. H. Gnauck, et al, “Dispersion Penalty Reduction Using an Optical Modulator with Adjustable Chirp, IEEE Photon. Technol. Lett. 3:916-918, 1991.

### BRIEF DESCRIPTION OF THE DRAWINGS

The present teachings, in accordance with preferred and exemplary embodiments, together with further advantages thereof, is more particularly described in the following detailed description, taken in conjunction with the accompanying drawings. The skilled person in the art will understand that the drawings, described below, are for illustration purposes only. The drawings are not necessarily to scale, emphasis instead generally being placed upon illustrating principles of the invention. The drawings are not intended to limit the scope of the Applicant's teachings in any way.

FIG. 1A illustrates a known optical transmitter with chirp control using a Mach-Zehnder interferometric modulator configured as an unbalanced drive device with two different modulation signal generators and independent phase control in each arm of the interferometer.

FIG. 1B illustrates a known optical transmitter with chirp control using a Mach-Zehnder interferometric modulator configured as an unbalanced drive device with non-equal splitting/combining ratios in at least one of the optical splitter and the optical combiner.

FIG. 2A illustrates an optical transmitter with chirp control using an unbalanced drive that is driven by a single modulation signal according to the present teaching.

FIG. 2B illustrates an optical transmitter with chirp control using an unbalanced drive that is driven by a dual modulation signal according to the present teaching.

FIG. 3A illustrates an eye diagram of a modulated optical signal generated by a known optical transmitter with a chirp parameter equal to −0.7.

FIG. 3B illustrates an eye diagram of a modulated optical signal generated by an optical transmitter according to the present invention with a chirp parameter equal to −0.7 and an input polarizer having a polarization axis that was chosen to maximize the extinction ratio of the modulated optical signal.

FIG. 3C illustrates an eye diagram of a modulated optical signal generated by an optical transmitter according to the present invention with a chirp parameter equal to −0.7 and an input polarizer having a polarization axis that was chosen to tune the chirp of the modulated optical signal.

FIG. 4A illustrates an eye diagram of a modulated optical signal generated by an optical transmitter according to the present invention having a polarization axis that was chosen to achieve maximum negative chirp for a 28 Gb/s signal propagating in an optical fiber with a dispersion of 200 ps/nm km.

FIG. 4B illustrates an eye diagram of a modulated optical signal generated by an optical transmitter according to the present invention having a polarization axis that was chosen to achieve maximum positive chirp for a 28 Gb/s signal propagating in an optical fiber with a dispersion of 200 ps/nm km.

### DESCRIPTION OF VARIOUS EMBODIMENTS

Reference in the specification to “one embodiment” or “an embodiment” means that a particular feature, structure, or characteristic described in connection with the embodiment is included in at least one embodiment of the teaching. The appearances of the phrase “in one embodiment” in various places in the specification are not necessarily all referring to the same embodiment.

It should be understood that the individual steps of the methods of the applicants' teachings may be performed in any order and/or simultaneously as long as the teachings remain operable. Furthermore, it should be understood that the apparatus and methods of the applicants' teachings can include any number or all of the described embodiments as long as the teachings remain operable.

The applicants' teachings will now be described in more detail with reference to exemplary embodiments thereof as shown in the accompanying drawings. While the applicants' teachings are described in conjunction with various embodiments and examples, it is not intended that the applicants' teachings be limited to such embodiments. On the contrary, the applicants' teachings encompass various alternatives, modifications and equivalents, as will be appreciated by those of skill in the art. Those of ordinary skill in the art having access to the teaching herein will recognize additional implementations, modifications, and embodiments, as well as other fields of use, which are within the scope of the present disclosure as described herein.

In one aspect of the present teaching, indium phosphide-based Mach-Zehnder modulators are used to provide modulation with a tunable chirp parameter. Indium phosphide-based Mach-Zehnder modulators have numerous desirable characteristics, such as being relatively small in size and having relatively low driving voltages. In addition, indium phosphide-based Mach-Zehnder modulators are well suited for integration with semiconductor lasers. Indium phosphide-based Mach-Zehnder modulators provide phase modulation by using an electrode sections which provides electrorefraction. The electro-optical phase change provided by the electrorefraction has a nonlinear relationship with the applied voltage, which is in contrast to LiNbO₃ modulators that achieve a refractive index change using the linear electro-optical effect. Consequently, phase change obtained in each of the arms of the Mach-Zehnder interferometric modulator is strongly bias dependent because of the nonlinear relationship with the applied voltage, particularly for multiple quantum well devices. Because such modulators are strongly dependent on bias, a greater phase change occurs in the arm that is modulated with the higher voltage values when they are configured in a push-pull driving configuration. This unbalance in the phase change tends to result in a positive chirp.

It has been demonstrated that chirp control can be achieved by shifting the operating point of the modulator by introducing a fixed phase shift between the modulator arms, which can be achieved by elongating one of the interferometer arms relative to the other interferometer arm. See, for example, J. Yu et al., Phase-Engineering III-V MQW Mach-Zehnder modulators, IEEE Photon. Technol. Lett. 9:1018-1020, 1996. In addition, chirp control can be achieved by using two different modulation signals to drive the Mach-Zehnder modulator.

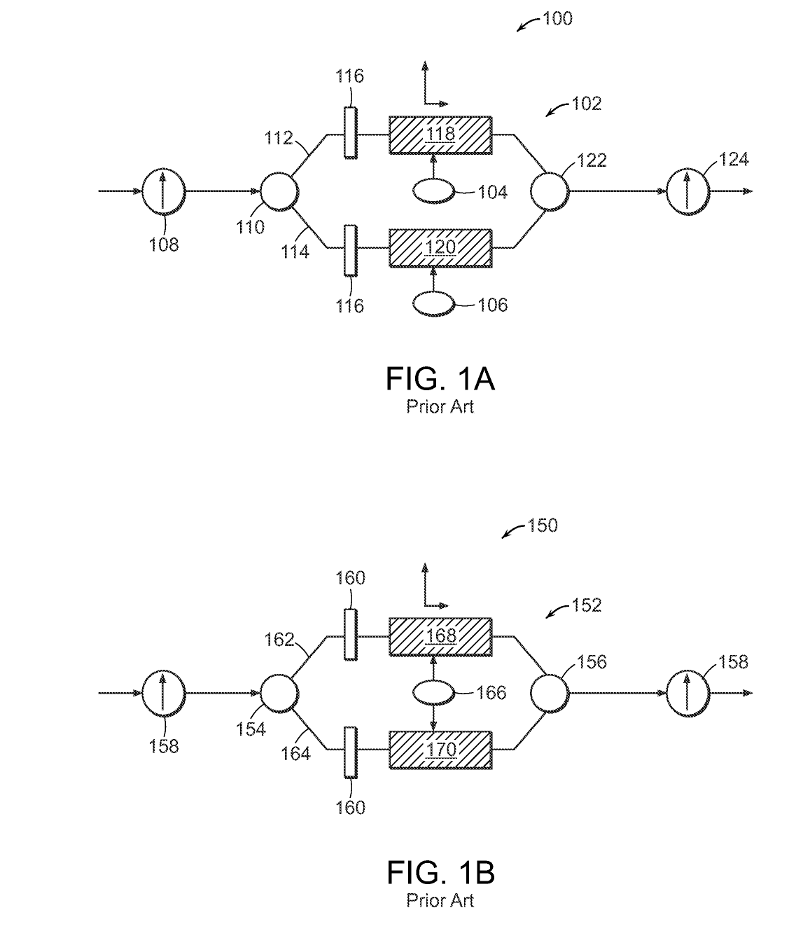

FIG. 1A illustrates a known optical transmitter 100 with chirp control using a Mach-Zehnder interferometric modulator 102 configured as an unbalanced drive device with two different modulation signal generators 104, 106 and independent phase control in each arm of the interferometer. Some known optical transmitters include an input polarizer 108 positioned at the input, which has a polarization axis that polarizes the input optical beam along the principle axis of the electro-optic material. The purpose of this input polarizer in these known optical transmitters is to improve the extinction ratio of the modulated optical signal. The present teaching relates at least in part to using an input polarizer to control the chirp of the modulated optical signal.

An optical splitter 110 is coupled to the output of the input polarizer 108. The optical splitter 110 splits the polarized optical beam into a first 112 and a second optical path 114. Some known optical transmitters with chirp control include a phase shifter 116 in one or both of the first 112 and the second optical path 114. Shifting the phase in one or both the first and the second optical paths 112, 114 with the phase shifters 116 can improve the modulation efficiency. Also, it has been shown that the chirp parameter of a Mach-Zehnder modulator can be varied from positive to negative by independently adjusting the phase in each arm of the Mach-Zehnder modulator. See, for example, S. K. Korotky et al., High-Speed Low-Power Optical Modulator with Adjustable Chirp Parameter, Integrated Photo. Res., Tech. Dig. Series, Vol., 9, pp 53, 1991.

The optical transmitter 100 also includes a first electro-optic waveguide 118 positioned in the first optical path 112 and a second electro-optic waveguide 120 positioned in the second optical path 114. The first electro-optic waveguide 118 includes a first modulation signal input and the second electro-optic waveguide 120 includes a second modulation signal input. The first modulation input is coupled to an output of the first modulation signal generator 104 and the second modulation input is coupled to an output of the second modulation signal generator 106. The output of the first electro-optic waveguide 118 is coupled to a first input of an optical combiner 122 and the output of the second electro-optic waveguide 120 is coupled to a second input of the optical combiner 122.

The output of the optical combiner 122 is coupled to an output polarizer 124. The output polarizer 124 has a polarization axis that polarizes the modulated optical beam along the principle axis of the electro-optic material. The use of the output polarizer is optional. The extinction ratio can be significantly improved by including an output polarizer that blocks undesirable polarizations from the modulated optical signal. Some experiments have shown a 4 db improvement in the extinction ratio.

In the optical transmitter of FIG. 1A, the chirp parameter of the Mach-Zehnder modulator can be varied from positive to negative by independently adjusting the phase change in each arm of the Mach-Zehnder modulator. In addition, the chirp parameter of the Mach-Zehnder modulator can be varied from positive to negative by properly selecting the first and the second modulation signals.

FIG. 1B illustrates a known optical transmitter 150 with chirp control using a Mach-Zehnder interferometric modulator 152 configured as an unbalanced drive device with non-equal splitting/combining ratios in at least one of the optical splitter 154 and the optical combiner 156. The optical transmitter 150 also includes an input polarizer 158 positioned at the input, which has a polarization axis that polarizes the input optical beam along the principle axis of the electro-optic material. In addition, the optical transmitter 150 includes phase shifters 160 for independent phase control in each of a first 162 and a second optical path 164.

The optical transmitter 150 of FIG. 1B is similar to the optical transmitter 100 of FIG. 1A. However, a single modulation signal generator 166 is used to modulate both the first electro-optic waveguide 168 and the second electro-optic waveguide 170. In addition, at least one of the optical splitter 154 and the optical combiner 156 has a splitting/combining ratio that is not equal to 50%/50%. In other words, the optical splitter 154 can be designed to split the polarized optical signal with an unequal ratio so that the magnitude of the optical signal in one of the first and second optical paths 162, 164 is different from the magnitude of the optical signal in the other one of the first and second optical paths 162, 164. Alternatively, the output combiner 156 can be designed to combine the optical signals propagating in the first and second optical paths 162, 164 in a non-equal ratio.

The electroabsorption associated with the change in the refractive index in the InP electro-optic waveguides in the Mach-Zehnder interferometric modulators is bias dependent. Therefore, there is typically a difference in the refractive index between the first and second electro-optic waveguides because of different bias conditions. This difference in the refractive index results in an imbalance of power in the two arms of the Mach-Zehnder interferometric modulator, which reduces the extinction ratio of the modulated optical signal. This imbalance of the power in the two arms of the interferometric modulator can be compensated for by changing the splitting ratio of the interferometer. However, changing the splitting ratio of the interferometer also affects the chirp parameter. A more desirable chirp parameter can be achieved by making the combining ratio of the optical combiner 156 something other than 50%/50%.

The output of the optical combiner 156 is coupled to an output polarizer 158. The output polarizer 158 has a polarization axis that polarizes the modulated optical beam along the principle axis of the electro-optic material comprising the first and the second electro-optic waveguides 168, 170. The use of the output polarizer is also optional. The extinction ratio can be significantly improved by using the output polarizer 158 to block undesirable polarizations from the modulated optical signal.

One aspect of the present teaching is an optical transmitter that controls the input polarization of the Mach-Zehnder interferometric modulator so that it is not exactly aligned to a principle axis of the electro-optic material forming the optical waveguides of the Mach-Zehnder interferometric modulator. The splitting ratio of the optical splitter is polarization dependent. Therefore, by controlling the alignment of the input polarization of the modulator so that it is not aligned to the principle axis of the electro-optic material forming the optical waveguides in the modulator, the chirp of the Mach-Zehnder interferometric modulator can be precisely controlled to achieve a desired chirp parameter.

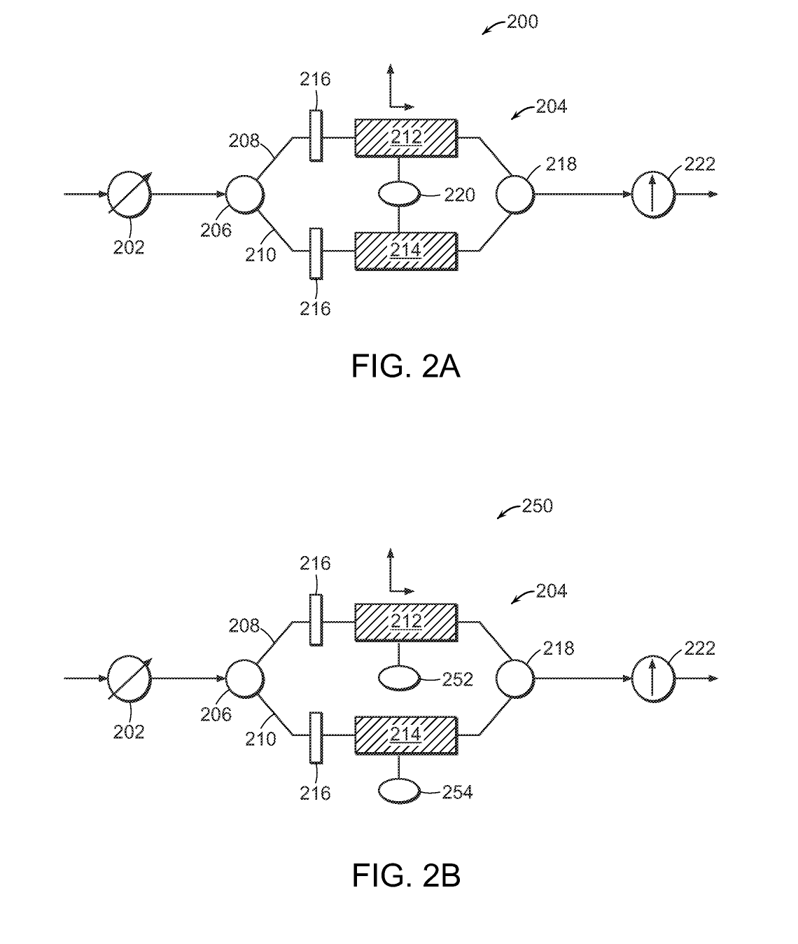

FIG. 2A illustrates an optical transmitter with chirp control using an unbalanced drive that is driven by a single modulation signal according to the present teaching. The optical transmitter 200 includes an input polarizer 202 having an input that receives an optical signal. The input polarizer 202 polarizes the optical signal along a desired input polarization axis. In some embodiments, the polarization axis of the input polarizer 202 is chosen to achieve a desired chirp of the modulated optical signal. Also, in some embodiments, the polarization axis of the input polarizer 202 is chosen to improve an extinction ratio of the modulated optical signal. Furthermore, in some embodiments, the polarization axis of the input polarizer 202 is chosen to both achieve a desired chirp of the modulated optical signal and to improve an extinction ratio of the modulated optical signal.

In addition, in some embodiments, the polarization axis of the input polarizer 202 is chosen to decrease Vπ of the Mach-Zehnder modulator 204. In one embodiment of the present teaching, the Mach-Zehnder modulator 204 comprises an indium phosphide Mach-Zehnder modulator. In another embodiment of the present teaching, the Mach-Zehnder modulator 204 comprises a GaAs Mach-Zehnder modulator. In yet another embodiment of the present teaching, the Mach-Zehnder modulator 204 comprises a SiGe Mach-Zehnder modulator. One skilled in the art will appreciate that numerous other types of optical modulators can be used to practice the present teaching. The Mach-Zehnder modulator 204 is a dual-drive device that is driven by a single modulation signal.

An optical input of the Mach-Zehnder modulator 204 is coupled to an output of the input polarizer 202. The Mach-Zehnder modulator 204 includes an optical splitter 206 having an input that is coupled to the output of the input polarizer 202. The optical splitter 202 splits the optical signal polarized along the input polarization axis into a first polarized optical signal at a first output that propagates along a first optical path 208 and a second polarized optical signal at a second output that propagates along a second optical path 210. In some embodiments, a splitting ratio of the optical splitter 206 is polarization dependent. That is, the fraction of the total input optical power of the optical signal that is polarized along the input polarization axis which is split into the first polarized optical signal is different from the fraction of the total input optical power of the optical signal that is polarized along the input polarization axis which is split into the second polarized optical signal.

A first electro-optic waveguide 212 is coupled to the first output of the splitter 206 so that the first polarized optical signal propagates along the first optical path 208 through the first electro-optic waveguide 212. The first electro-optic waveguide 212 includes a first electrical modulation input that receives a first modulation signal. A second electro-optic waveguide 214 is coupled to the second output of the splitter 206 so that the second polarized optical signal propagates along the second optical path 210 through the second electro-optic waveguide 214. The second electro-optic waveguide 214 includes a second electrical modulation input that receives a second modulation signal. The first and second electro-optic waveguides 212, 214 can be formed of various electro-optic materials such as InP, GaAs, and SiGe.

In one embodiment, a phase shifter is positioned in only the first optical path 208 (not shown). In another embodiment, phase shifters 216 are positioned in both the first and second optical paths 208, 210. The phase shifters 216 can be used to compensate for small differences in optical path length in the first and the second optical paths 208, 210. Properly adjusting the phase shifters 216 in one or both of the first and second optical paths 208, 210 will improve the modulation efficiency.

An optical combiner 218 includes a first input that is coupled to the first electro-optic waveguide 212 and a second input that is coupled to the second electro-optic waveguide 214. The output of the optical combiner 218 forms the output of the Mach-Zehnder modulator 204.

A modulation signal generator 220 generates an electrical modulation signal at an output. The output of the modulation signal generator 220 is electrical connected to both the first and the second modulation inputs of the Mach-Zehnder modulator 204. The Mach-Zehnder modulator 204 modulates the optical signal with the electrical modulation signal and generates a modulated optical signal at an output with the desired chirp that is selected by the input polarization axis of the input polarizer 202. In some embodiments of the present teaching, the phase shift imparted by the phase shifters 216 and the relative lengths of the first and second electro-optic waveguides 212, 214 are chosen so that the optical signals propagating in the first and the second optical paths 208, 210 constructively combine at the optical combiner 218.

An output polarizer 222 having an input that is optically coupled to the output of the Mach-Zehnder modulator 204 is used to polarize the modulated optical signal. In some embodiments of the present teaching, the polarization axis of the output polarizer 212 is chosen to combines TE and TM mode polarizations. In some embodiments of the present teaching, an output polarization axis of the output polarizer 222 is aligned to a principle axis of electro-optic material comprising the Mach-Zehnder modulator 204.

FIG. 2B illustrates an optical transmitter 250 with chirp control using an unbalanced drive that is driven by a dual modulation signal according to the present teaching. The optical transmitter 250 is similar to the optical transmitter 200 that was described in connection with FIG. 2A. However, in this embodiment, a first modulation signal generator 252 generates a first electrical modulation signal that is applied to the modulation input of the first electro-optic waveguide 212 and a second modulation signal generator 254 generates a second electrical modulation signal that is applied to the modulation input of the second electro-optic waveguide 214. Modulating the first and second electro-optic waveguides with different modulation signals provides addition control over the chirp and the extinction ration of the modulated optical signal.

Referring to FIGS. 2A and 2B, a method of generating a modulated optical signal with a controllable chirp according to the present teaching includes polarizing an optical signal along an input polarization axis of the polarizer 202. The input polarization axis is adjusted to achieve a desired chirp parameter of the modulator 204. In addition, some methods include adjusting the input polarization axis to increase an extinction ratio of the resulting modulated optical signal. Also, some methods include adjusting the input polarization axis of the polarizer 202 to decrease a Vπ of the modulator 204.

The optical signal polarized along the input polarization axis of the polarizer 202 is then modulated with the Mach-Zehnder modulator 204 by splitting the optical signal polarized along the input polarization axis of the polarizer 202 into a first polarized optical signal and a second polarized optical signal. The first polarized optical signal is propagated through a first electro-optic waveguide 212 having a modulation input that receives a first modulation signal and the second polarized optical signal is propagated through a second electro-optic waveguide 214 having a modulation input that receives a second modulation signal.

The first and second polarized optical signals are then combined with the optical combiner 218, thereby generating the modulated optical signal. In various embodiments, the first and the second modulation signals are the same modulation signal (FIG. 2A) or different modulation signals (FIG. 2B). The resulting modulated optical signal is polarized along a desired output polarization axis that combines TE and TM mode polarizations. In some embodiments, the phase of at least one of the first polarized optical signal and the second polarized optical signal is shifted with the phase shifter 216 to improve at least one of the extinction ratio and the modulation efficiency.

Using the methods and apparatus of the present teaching, the chirp of the modulated optical signal can be changed from a high positive value to a high negative value. Also, the methods and apparatus of the present teaching can be used to improve the extinction ratio of the modulated optical signal. Furthermore, the methods and apparatus of the present teaching can be used to increase the optical power.

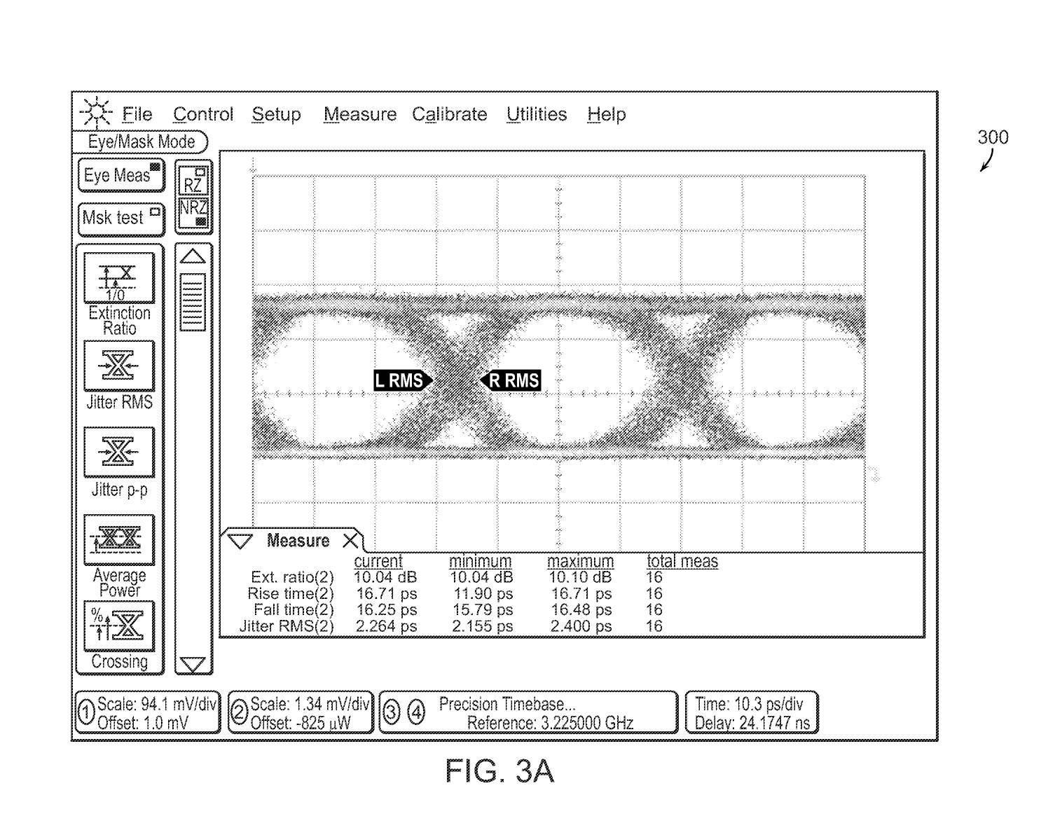

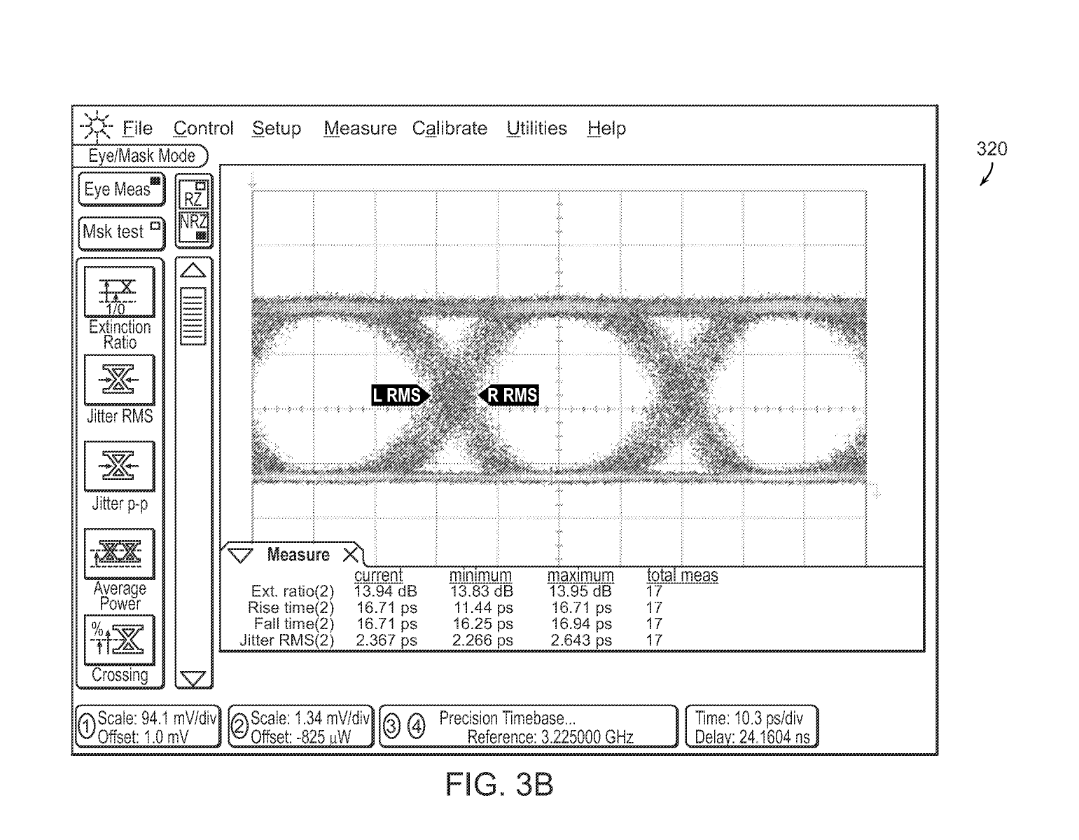

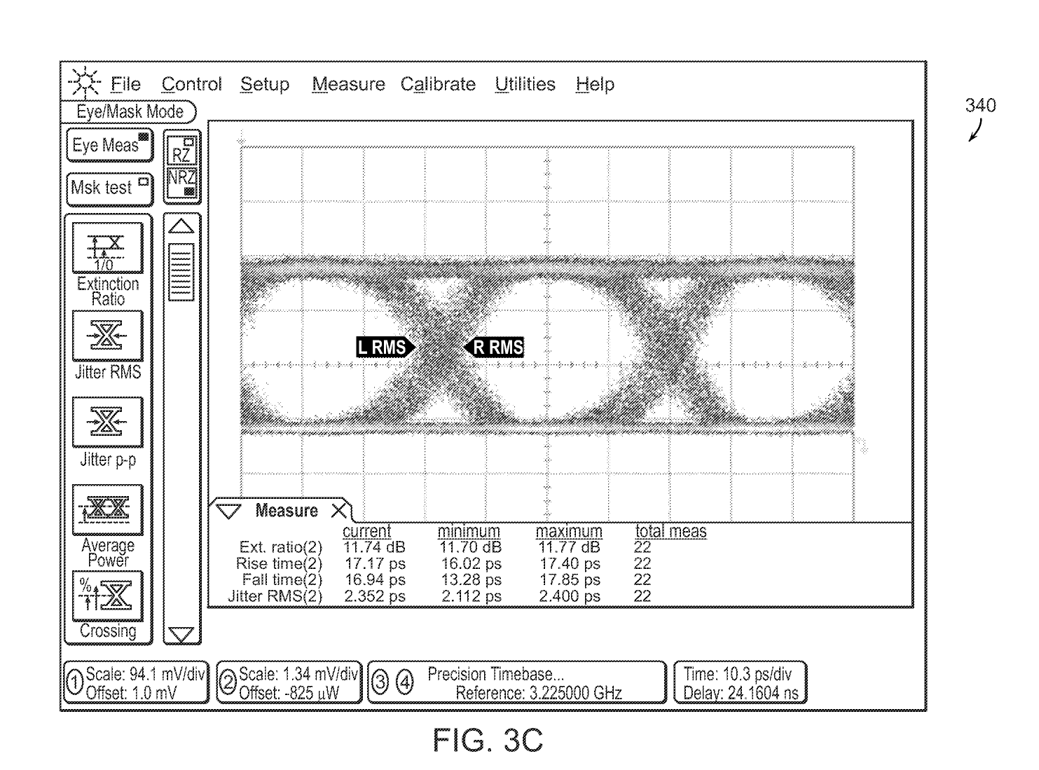

FIG. 3A illustrates an eye diagram 300 of a modulated optical signal generated by a known optical transmitter with a chirp parameter equal to −0.7. No input polarizer was used before the input to the Mach-Zehnder modulator. The optical power generated was −2.5 dBm and the extinction ratio was 10.4 dB.

FIG. 3B illustrates an eye diagram 320 of a modulated optical signal generated by an optical transmitter according to the present invention with a chirp parameter equal to −0.7 and an input polarizer 202 having a polarization axis that was chosen to maximize the extinction ratio of the modulated optical signal. The insertion loss of the input polarizer 202 was about 1.7 dB. The extinction ratio was about 13.94 dB. The optical power of the modulated optical signal was about −7.1 dBm. Therefore, the use of the input polarizer 202 in this example, according to the present teaching, resulted in the maximum extinction ratio in the modulated optical signal at the cost of 4.6 dBm in the optical power.

FIG. 3C illustrates an eye diagram 340 of a modulated optical signal generated by an optical transmitter according to the present invention with a chirp parameter equal to −0.7 and an input polarizer 202 having a polarization axis that was chosen to tune the chirp of the modulated optical signal. The insertion loss of the input polarizer 202 was about 1.7 dB. The extinction ratio was about 11.7 dB. The optical power of the modulated optical signal was −4.2 dBm. Therefore, the use of the input polarizer 202 in this example, according to the present teaching, resulted in a significantly higher extinction ratio in the modulated optical signal at the cost of 1.7 dB loss in optical power resulting from the insertion loss of the input polarizer 202.

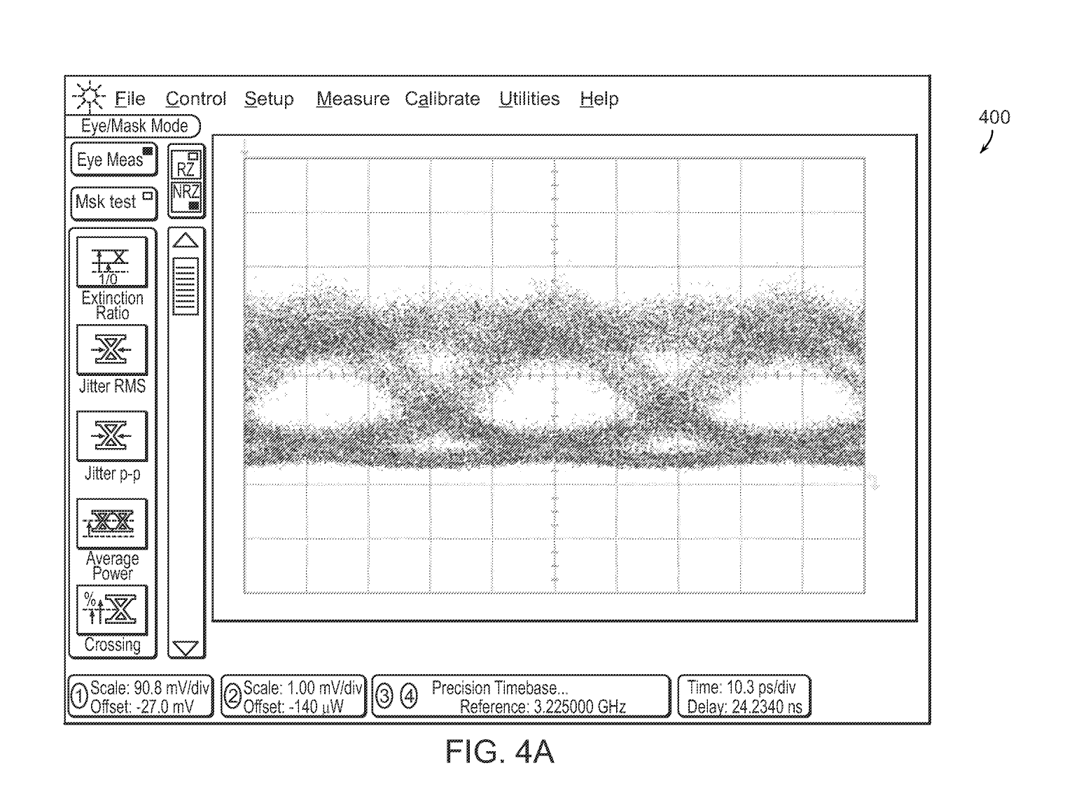

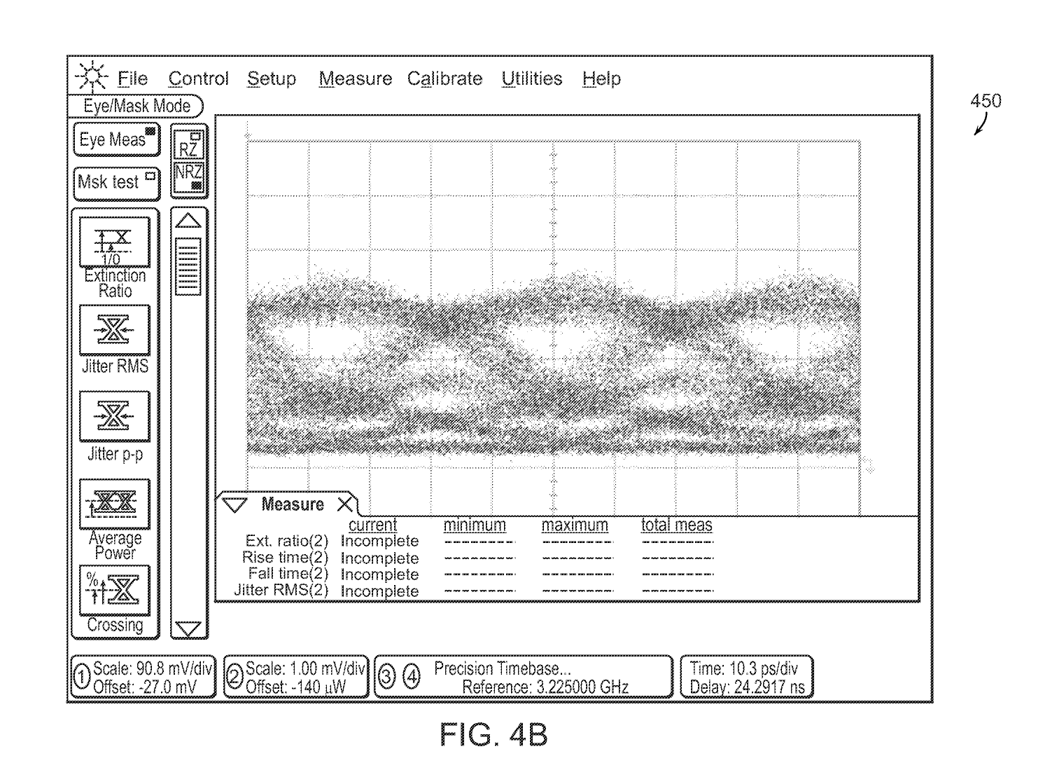

FIG. 4A illustrates an eye diagram of a modulated optical signal generated by an optical transmitter according to the present invention having input polarizer 202 having a polarization axis that was chosen to achieve maximum negative chirp for a 28 Gb/s signal propagating in an optical fiber with a dispersion of 200 ps/nm.

FIG. 4B illustrates an eye diagram of a modulated optical signal generated by an optical transmitter according to the present invention having an input polarizer 202 having a polarization axis that was chosen to achieve maximum positive chirp for a 28 Gb/s signal propagating in an optical fiber with a dispersion of 200 ps/nm km. Comparing the eye diagrams of FIGS. 4A and 4b, there is significantly more noise when the polarization axis is chosen to achieve maximum positive chirp.

### Equivalents

While the Applicants' teachings are described in conjunction with various embodiments, it is not intended that the Applicants' teachings be limited to such embodiments. On the contrary, the Applicants' teachings encompass various alternatives, modifications, and equivalents, as will be appreciated by those of skill in the art, which may be made therein without departing from the spirit and scope of the teaching.

What is claimed is:

1. An optical transmitter with chirp control, the transmitter comprising:
a. an input polarizer having an input that receives an optical signal, the input polarizer polarizing the optical signal along an input polarization axis;
b. a Mach-Zehnder modulator having an optical input that is coupled to an output of the input polarizer and an electrical input that receives a modulation signal, the Mach-Zehnder modulator modulating the optical signal with the modulation signal, wherein the input polarization axis of the input polarizer is chosen to achieve a desired chirp of the modulated optical signal;
c. an output polarizer having an input that is coupled to the output of the Mach-Zehnder modulator, the output polarizer polarizing the modulated optical signal along a desired output polarization axis that combines TE and TM mode polarizations.

2. The optical transmitter of claim 1 wherein the Mach-Zehnder modulator comprises an InP Mach-Zehnder modulator.

3. The optical transmitter of claim 1 wherein the Mach-Zehnder modulator comprises a GaAs Mach-Zehnder modulator.

4. The optical transmitter of claim 1 wherein the Mach-Zehnder modulator comprises a SiGe Mach-Zehnder modulator.

5. The optical transmitter of claim 1 wherein the input polarization axis of the input polarizer is chosen to improve an extinction ratio of the modulated optical signal.

6. The optical transmitter of claim 1 wherein the input polarization axis of the input polarizer is chosen to decrease Vπ of the Mach-Zehnder modulator.

7. The optical transmitter of claim 1 wherein the input polarization axis of the input polarizer is chosen to achieve a desired chirp parameter of the Mach-Zehnder modulator.

8. The optical transmitter of claim 1 wherein the output polarization axis of the output polarizer is aligned to a principle axis of electro-optic material comprising the Mach-Zehnder modulator.

9. An optical transmitter with chirp control, the transmitter comprising:
a. an input polarizer having an input that receives an optical signal, the input polarizer polarizing the optical signal along an input polarization axis;
b. a Mach-Zehnder modulator having an input that is coupled to the output of an input polarizer, the Mach-Zehnder modulator comprising:
i. an optical splitter that splits the optical signal polarized along the input polarization axis into a first and a second optical path;
ii. a first electro-optic waveguide coupled into the first optical path and having an electrical modulation input that receives a first modulation signal;
iii. a second electro-optic waveguide optically coupled into the second optical path and having an electrical modulation input that receives a second modulation signal; and
iv. an optical combiner having a first input that is coupled to the first electro-optic waveguide and a second input that is coupled to the second electro-optic waveguide, an output of the optical combiner generating a modulated optical signal, wherein the input polarization axis of the input polarizer is chosen to achieve a desired chirp of the modulated optical signal; and
c. an output polarizer having an input that is coupled to the output of the Mach-Zehnder modulator, the output polarizer polarizing the modulated optical signal along an axis that combines the TE and TM mode polarizations.

10. The optical transmitter of claim 9 wherein a splitting ratio of the optical splitter in the Mach-Zehnder modulator is polarization dependent.

11. The optical transmitter of claim 9 wherein the first and the second modulation signal are the same modulation signal.

12. The optical transmitter of claim 9 wherein the first and the second modulation signal are different modulation signals.

13. The optical transmitter of claim 9 wherein the first and second electro-optic waveguides comprise InP.

14. The optical transmitter of claim 9 wherein the first and second electro-optic waveguides comprise GaAs.

15. The optical transmitter of claim 9 wherein the first and second electro-optic waveguides comprise SiGe.

16. The optical transmitter of claim 9 wherein the Mach-Zehnder modulator comprises a phase shifter in the first optical path.

17. The optical transmitter of claim 9 wherein the Mach-Zehnder modulator comprises a first phase shifter in the first optical path and a second phase shifter in the second optical path.

18. The optical transmitter of claim 9 wherein the output polarizer polarizes the modulated optical signal along a principle axis of the first and second electro-optic waveguides.

19. The optical transmitter of claim 9 wherein the input polarization axis of the input polarizer is chosen to increase an extinction ratio of the modulated optical signal.

20. The optical transmitter of claim 9 wherein the input polarization axis of the input polarizer is chosen to decrease a Vπ of the Mach-Zehnder modulator.

21. The optical transmitter of claim 9 wherein the input polarization axis of the input polarizer is chosen to achieve a desired chirp parameter of the Mach-Zehnder modulator.

22. A method of generating a modulated optical signal with a controllable chirp, the method comprising:
a. polarizing an optical signal along an input polarization axis;
b. modulating the optical signal polarized along the input polarization axis with a Mach-Zehnder modulator; and
c. polarizing the modulated optical signal along a desired output polarization axis that combines TE and TM mode polarizations, wherein the input polarization axis is chosen to achieve a desired chirp of the modulated optical signal.

23. The method of claim 22 further comprising adjusting the input polarization axis to increase an extinction ratio of the modulated optical signal.

24. The method of claim 22 further comprising adjusting the input polarization axis to decrease a Vπ of the Mach-Zehnder modulator.

25. The method of claim 22 further comprising adjusting the input polarization axis to achieve a desired chirp parameter of the Mach-Zehnder modulator.

26. The method of claim 22 wherein the modulating the optical signal comprises:
a. splitting the optical signal polarized along the input polarization axis into a first optical polarized optical signal and a second optical polarized optical signal;
b. propagating the first polarized optical signal through a first electro-optic waveguide having a modulation input that receives a first modulation signal;
c. propagating the second polarized optical signal through a second electro-optic waveguide having a modulation input that receives a second modulation signal; and
d. combining the first and second polarized optical signal, thereby generating the modulated optical signal.

27. The method of claim 26 wherein the first and the second modulation signal are the same modulation signal.

28. The method of claim 26 wherein the first and the second modulation signal are different modulation signals.

29. The method of claim 26 further comprising shifting a phase of at least one of the first polarized optical signal and the second polarized optical signal.
